(19) United States
(12) Patent Application Publication
(10) Pub. No.: US 2007/0137600 A1
(43) Pub. Date: Jun. 21, 2007

(54) Lead for use in rotary electric machine

(75) Inventor: Tatsuya Saito, Chiryu-shi (JP)

Correspondence Address: OLIFF & BERRIDGE, PLC, P.O. BOX 19928, ALEXANDRIA, VA, 22320, US

(73) Assignee: DENSO CORPORATION, KARIYA-CITY (JP)

(21) Appl. No.: 11/633,412

(22) Filed: Dec. 5, 2006

(30) Foreign Application Priority Data
Dec. 16, 2005 (JP) 2005-363575

(51) Int. Cl. F02N 17/00

(52) U.S. Cl. 123/179.1

(57) ABSTRACT

A lead for use in a rotary electric machine such as an automotive engine starter. The lead includes a tube having formed on an end thereof a grommet to be secured to the machine and a stranded conductor disposed within the tube to have an end portion extending inside the machine through a hole of the grommet. The tube has a seal which is interference fit on the stranded conductor, while the stranded conductor is not interference fit on the stranded conductor. This permits the grommet to be pushed by a decreased pressure while flexing or compressing the tube in a lengthwise direction thereof thereby exposing more area of the end portion of the stranded conductor when welded to, for example, a motor terminal within the machine.

### CROSS REFERENCE TO RELATED DOCUMENT

The present application claims the benefit of Japanese Patent Application No. 2005-363575 filed on Dec. 16, 2005, the disclosure of which is incorporated herein by reference.

### BACKGROUND OF THE INVENTION

1. Technical Field of the Invention

The present invention relates generally to a lead for use in establishing an electric connection with an internal part of a rotary electric machine such as an automotive engine starter, and more particularly to the structure of such a lead equipped with a stranded conductor which extends at an end thereof inside a frame of a rotary electric machine through a grommet.

2. Background Art

Japanese Patent First Publication No. 2005-33955 discloses a rotary electric machine used as a starter to start an automotive engine. The rotary electric machine is equipped with a lead extending from inside a motor casing through a grommet. Specifically, the lead has an end portion compressed by, for example, a brazing filler metal, which passes through the grommet and connects with a terminal of an electric motor. The end portion is interference fit in a hole of the grommet to establish hermetical sealing between the lead and the grommet.

Japanese Utility Model Second Publication No. 6-35649 discloses an electric motor equipped with a tube formed integrally with a grommet and a lead wire extending inside the tube to make an electric connection at an end thereof with a motor terminal of a solenoid switch.

FIG. 6 shows an example of a conventional lead 200 which consists essentially of a tube 100 and a stranded conductor 120 made up of a plurality of twisted wires. The stranded conductor 120 extends through the tube 100. The tube 100 has an integrally formed grommet 110 secured to a motor casing. The stranded conductor 120 has an end portion 130 which is interference fit in the grommet 110 to establish hermetic sealing between the grommet 110 and the stranded conductor 120. The stranded conductor 120 is jointed within the motor casing to an internal conductor 160 such as a brush pigtail or a connection bar. Such joining is achieved by pushing the grommet 110 in a leftward direction, as indicated by an arrow, to flex the tube 100, thereby exposing more area of the end of the stranded conductor 120 inside the motor casing and welding the end with the internal conductor 160. The end portion 130 of the stranded conductor 120 is, as described above, interference fit in the grommet 140 to make a hermetic seal 140, thus resulting in an increase in pressure required to push the grommet 110 in the leftward direction to flex the tube 100. When the grommet 110 is pushed to flex the tube 100, it will cause the stranded conductor 120 to be compressed by the grommet 110 in a lengthwise direction, thus resulting in an increased difficulty in returning the stranded conductor 120 back to its original position.

When water has entered at an open end of the tube 100 and stayed inside the tube 100, it will cause the water to pass through the seal 140 and enter the motor casing for a long time, thus resulting in rusting of parts within the motor casing.

### SUMMARY OF THE INVENTION

It is therefore a principal object of the invention to avoid the disadvantages of the prior art.

It is another object of the invention to provide an improved structure of a lead for use in a rotary electric machine which is designed to improve welding activity to weld the lead and attachment of a grommet to a frame of the rotary electric machine, and minimize penetration of water into a frame.

According to one aspect of the invention, there is provided a lead for use in establishing an electrical connection with a part of a rotary electric machine such as an automotive engine starter. The lead comprises: (a) a tube having formed on an end thereof a grommet with a hole to be secured to a frame of the rotary electric machine; (b) a stranded conductor disposed inside the tube to have an end portion extending through the hole of the grommet, the stranded conductor having an outer diameter which is substantially identical or smaller than an inner diameter of the hole of the grommet; and (c) a seal provided on the tube, the seal being interference fit on the stranded conductor to establish hermetic sealing between the tube and the stranded conductor.

The grommet does not hermetically seal, that is, is not interference fit on the stranded conductor. This permits the grommet to be pushed by a decreased pressure while flexing or compressing the tube in a lengthwise direction thereof to expose more area of the end portion of the stranded conductor when being connected electrically with an internal terminal of the rotary electric machine and also facilitates returning of the grommet to its original position.

In the preferred mode of the invention, the seal is located at the middle of a length of the tube, thereby resulting in a decrease in pressure required to deform or flex the tube to expose the end portion of the stranded conductor from the grommet.

The seal may alternatively be located at the side of the middle of the length of the tube opposite the grommet, thereby further decreasing the pressure required to deform or flex the tube.

The seal may also alternatively be located closer to the grommet than the middle of the length of the tube. This facilitates bending of the lead when an end of the lead is connected electrically to, for example, an external terminal of the rotary electric machine.

The stranded conductor has a small-diameter portion which is compressed radially and tightly. The seal is interference fit on the small-diameter portion, thereby holding water having penetrated into the stranded conductor through capillary activity from flowing inside the rotary electric machine.

The seal may have formed thereon at least two sealing portions which are both interference fit on an outer periphery of the stranded conductor, thereby enhancing the sealing ability.

The sealing portions may be located at a given interval along the length of the tube.

According to the second aspect of the invention, there is provided a rotary electric machine which comprises: (a) a frame which defines a casing; (b) an electric motor disposed within the casing, the electric motor being equipped with an armature which produces torque through electromagnetic power; (c) a solenoid switch designed to energize the electric motor selectively; and (d) a lead including (1) a tube having formed on an end thereof a grommet with a hole secured to the frame, (2) a stranded conductor disposed inside the tube, the stranded conductor having an outer diameter which is substantially identical or smaller than an inner diameter of the hole of the grommet, and (3) a seal provided on the tube which is interference fit on the stranded conductor to establish hermetic sealing between the tube and the stranded conductor. The stranded conductor has a first end portion and a second end portion opposite the first end portion. The first end portion extends through the hole of the grommet to make an electric connection with an internal conductor of the motor within the frame. The stranded conductor extends outside the frame from the first end portion to make an electric connection at the second end portion with a motor terminal of the solenoid switch.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a partially longitudinal sectional view which shows an internal structure of a lead for use in a rotary electric machine according to the first embodiment of the invention;

FIG. 2 is a partially longitudinal sectional view which shows the lead of FIG. 1 when a grommet is pushed to flex a tube to expose more area of an end of a stranded conductor when welded to an internal conductor of a motor;

FIG. 3 is a plane view which shows a rotary electric machine used as an engine starter equipped with the lead, as illustrated in FIG. 1;

FIG. 4 is a longitudinal sectional view which shows the lead of FIG. 1 when connected with a solenoid switch;

FIG. 5 is a partially longitudinal sectional view which shows a lead according to the second embodiment of the invention; and

FIG. 6 is a longitudinal sectional view which shows an example of a conventional lead.

### DESCRIPTION OF THE PREFERRED EMBODIMENTS

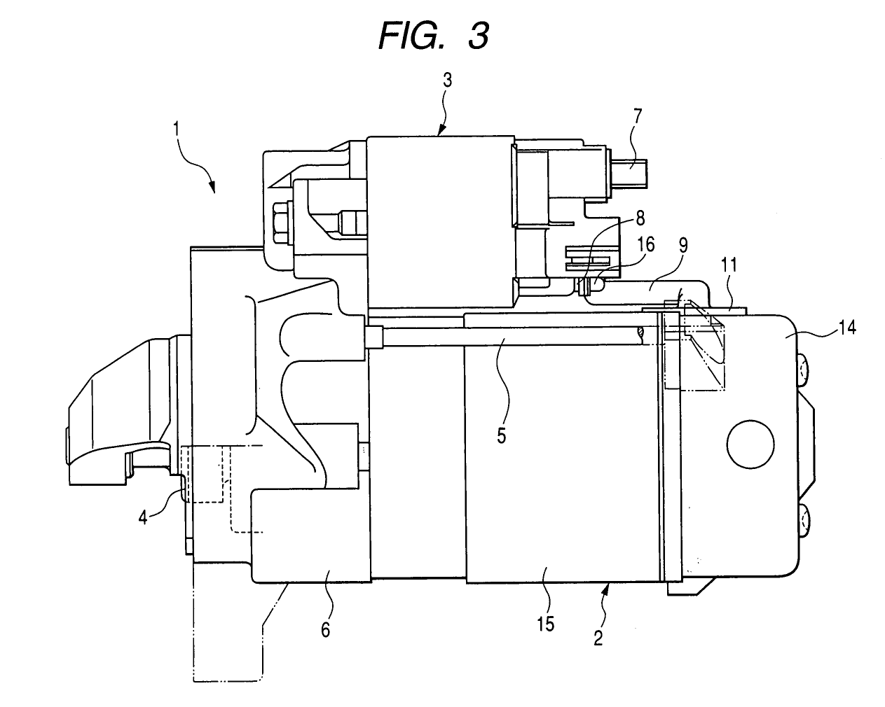

Referring to the drawings, wherein like reference numbers refer to like parts in several views, particularly to FIG. 3, there is shown an electric rotary machine according to the first embodiment of the invention which is designed as an automotive starter 1 working to start an internal combustion engine.

The starter 1 includes generally an electric motor 2, an solenoid switch 3, and a pinion gear 4. The solenoid switch 3 works to close or open a main contact, as will be described later, installed in a motor circuit to energize or deenergize the motor 2. The motor 2 works to produce and transmit torque to the pinion gear 4. The pinion gear 4 is moved into engagement with a ring gear (not shown) fitted on the engine to start the engine. This operation is well known in the art, and explanation thereof in detail will be omitted here. For instance, Japanese Patent First Publication No. 2005-33955, as referred to in the introductory part of this application, discloses the structure and operation of such a type of starter, the disclosure of which is incorporated herein by reference.

The motor 2 is a dc motor equipped with an armature which is operable to produce the torque through electromagnetic power. The motor 2 is, as clearly shown in FIG. 3, joined firmly to a front housing 6 using through-bolts 5.

The solenoid switch 3 is equipped with a pair of stationary contacts (not shown) connected to the motor circuit through two external terminals 7 and 8, a moving contact (not shown) working to connect or disconnect between the stationary contacts, and a solenoid (not shown) operable to produce magnetic attraction to move the moving contact. When the stationary contacts are connected electrically together through the moving contact, it will cause the main contact to be turned on or closed. Alternatively, when the stationary contacts are disconnected from each other, it will cause the main contact to be turned off or opened.

The external terminal 7 is to be connected to a storage battery installed in the vehicle through a battery cable and will be referred to as a B-terminal below. The external terminal 8 is connected to a lead 9 extending from the motor 2 and will be referred to as an M-terminal below.

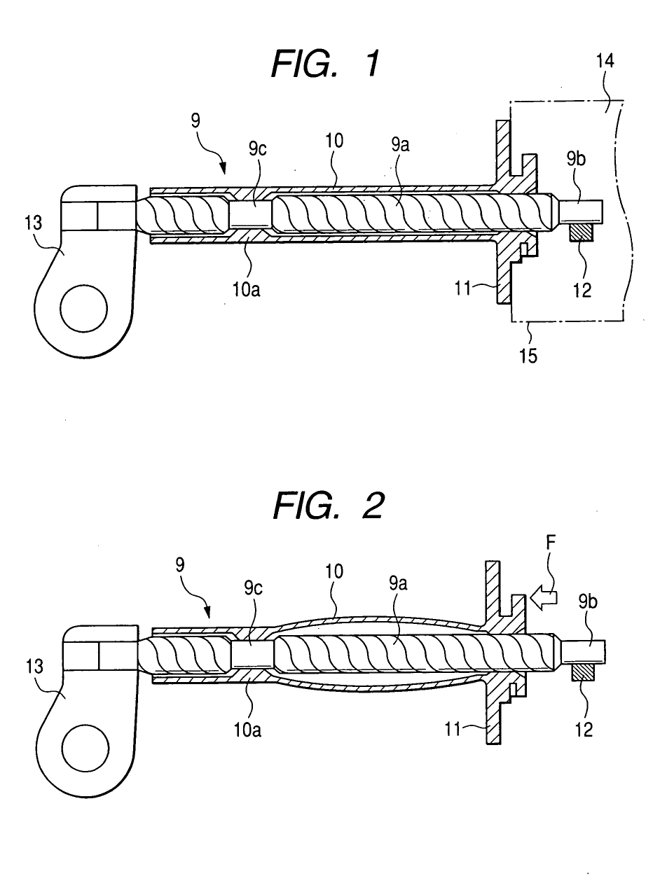

The lead 9 is, as clearly shown in FIG. 1, made up of a stranded conductor 9a formed by a bundle of copper wires twisted together and an insulating tube 10 wrapped about the stranded conductor 9a. The tube 10 is formed integrally with a grommet 11.

The stranded conductor 9a extends at an end thereof inside the motor 2 through the grommet 11 to have an inner terminal 9b welded to an internal conductor 12 (e.g., a connection bar or a brush pigtail) of the motor 2. The stranded conductor 9a also has the other end which extends outside the tube 10 and is joined to a terminal 13. The terminal 13 is connected electrically to the M-terminal 8, as illustrated in FIG. 3, of the solenoid switch 3. The stranded conductor 9a also has a small-diameter portion 9c formed at the middle thereof in a lengthwise direction. The small-diameter portion 9c is made by welding portions of the wires of the stranded conductor 9a together using, for example, a brazing filler metal to compress them radially.

The grommet 11 is made of rubber. The grommet 11 is, as illustrated in FIG. 3, secured to an end frame 14 covering a rear portion of the motor 2 and retained between the end frame 14 and the motor yoke 15.

The grommet 11 has formed therein a hole through which the stranded conductor 9a passes. The inner diameter of the hole is equal to or slightly greater than the outer diameter of the stranded conductor 9a.

The tube 10 has an inner diameter slightly greater than the outer diameter of the stranded conductor 9a in order to facilitate ease of insertion of the stranded conductor 9a thereinto. The tube 10 has, as illustrated in FIG. 1, formed at the middle thereof a seal 10a which is interference fit on the small-diameter portion 9c of the stranded conductor 9a to hermetically seal the small-diameter portion 9c. The seal 9c is formed by a thick-walled portion of the tube 10 having an inner diameter slightly smaller than the outer diameter of the small-diameter portion 9c.

The lead 9 extends, as can be seen from FIG. 3, from inside to outside the motor 2 and then is angled toward the front of the starter 1 (i.e., a leftward direction, as viewed in the drawing) in parallel to the outer periphery of the motor yoke 15. The lead 9 is angled again upright near the M-terminal 8 of the solenoid switch 3 to connect the terminal 13 to the M-terminal 8 firmly through a nut 16.

The above described structure of the lead 9 offers the following beneficial advantages.

The hole of the grommet 11 is, as already described, identical with or slightly greater than the outer diameter of the stranded conductor 9a. In other words, the grommet 11 does not hermetically seal, that is, is not interference fit on the stranded conductor 9a. This permits the grommet 11, as illustrated in FIG. 2, to be pushed by a decreased pressure F while flexing or compressing the tube 10 in a lengthwise direction thereof (i.e., the leftward direction in the drawing) without shifting the seal 9c on the stranded conductor 9a, thereby exposing more area of the end portion of the stranded conductor 9a when the inner conductor 12 of the motor 2 is welded to the inner terminal 9b of the stranded conductor 9a.

When the grommet 11 is pushed by the pressure F, the stranded conductor 9a is not cramped tightly by the grommet 11, thus facilitating returning of the grommet 11 to its original position after the internal conductor 12 is welded to the internal terminal 9b. This results in improved workability of welding the internal conductor 12 to the internal terminal 9b and securing the grommet 11 to the end frame 14.

The seal 10a of the tube 10 works to avoid penetration of water having entered at an open end of the tube 10 into the motor 2.

The small-diameter portion 9c of the stranded conductor 9a on the periphery of which the seal 10a is fitted is, as described above, compressed tightly in a radius direction thereof, thus establishing a liquid-tight seal working to hold water having penetrated into the stranded conductor 9a through capillary activity from flowing to the side of the motor 2, which will minimize rusting of motor 2.

As compared with the case where the grommet 11 has the seal 10a, the structure of the lead 9 of this embodiment permits the distance between the open end and the seal 10a of the tube 10 to be decreased to decrease the amount of water staying inside the tube 10, thus minimizing the water penetrating the motor 2.

The seal 10a is, as described above, formed at the middle of the tube 10 distant from the grommet 11, thereby resulting in a decrease in pressure F required to deform or flex the tube 10 to expose the end portion of the stranded conductor 9a from the grommet 11 when the terminal 9b is welded to the internal conductor 12 of the motor 2.

The seal 10a may alternatively be located at the side (i.e., the left side, as viewed in FIG. 2) of the middle of the length of the tube 10 opposite the grommet 11 in order to further decrease the pressure F required to deform or flex the tube 10.

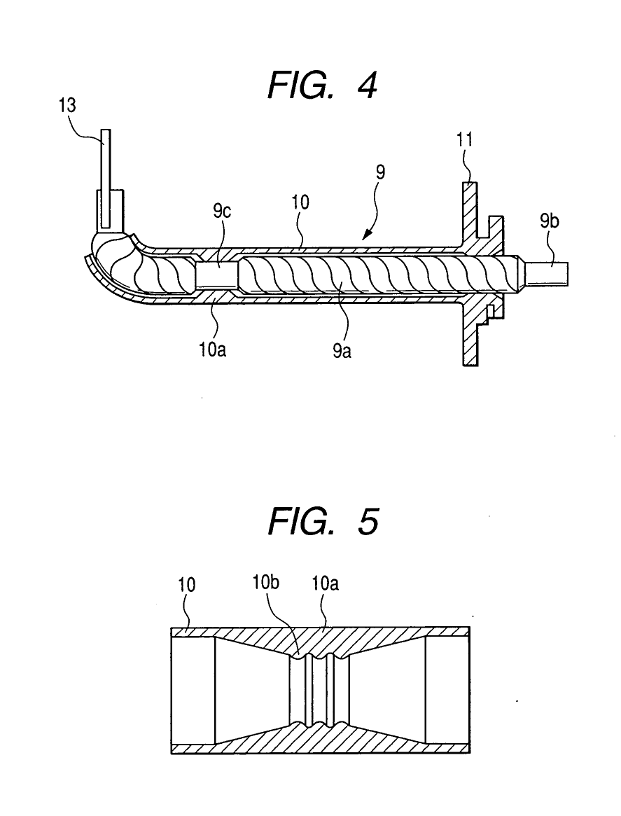

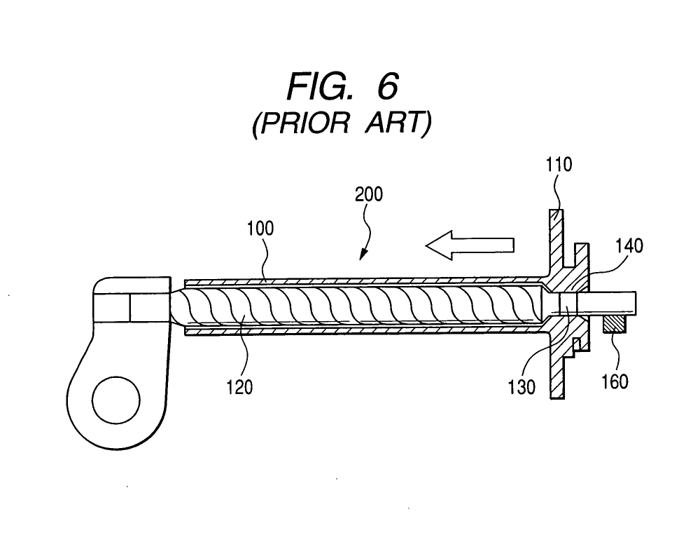

The structure of the tube 10 also permits, as illustrated in FIG. 4, the open end portion thereof to be bent upright, as viewed in the drawing, easily when the terminal 13 is connected to the M-terminal 8.

The seal 10a may also alternatively be located closer to the grommet 11 than the middle of the length of the tube 10. This further facilitates the bending of the lead 9 when the terminal 13 is connected electrically to the M-terminal 8 of the solenoid switch 3.

FIG. 5 illustrates the seal 10a of the tube 10 according to the second embodiment of the invention.

The seal 10a has at least two (three in this embodiment) annular ribs 10b which are located at a given interval away from each other in the lengthwise direction of the tube 10 and interference fit on the periphery of the small-diameter portion 9c of the stranded conductor 9a to establish a plurality of liquid-tight seals between the tube 10 and the stranded conductor 9a, thereby enhancing the sealing ability of the seal 10a. Other arrangements are identical with those in the first embodiment, and explanation thereof in detail will be omitted here.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims.

What is claimed is:

1. A lead for use in establishing an electrical connection with a part of a rotary electric machine comprising:
a tube having formed on an end thereof a grommet with a hole to be secured to a frame of the rotary electric machine;
a stranded conductor disposed inside said tube to have an end portion extending through the hole of the grommet, said stranded conductor having an outer diameter which is substantially identical or smaller than an inner diameter of the hole of the grommet; and
a seal provided on said tube, said seal being interference fit on said stranded conductor to establish hermetic sealing between said tube and said stranded conductor.

2. A lead as set forth in claim 1, wherein said seal is located at substantially a middle of a length of said tube.

3. A lead as set forth in claim 1, wherein said seal is located at a side of a middle of a length of said tube opposite the grommet.

4. A lead as set forth in claim 1, wherein said seal is located closer to the grommet than a middle of a length of said tube.

5. A lead as set forth in claim 1, wherein said stranded conductor has a small-diameter portion which is compressed radially, and wherein said seal is interference fit on the small-diameter portion.

6. A lead as set forth in claim 5, wherein said seal has formed thereon at least two sealing portions which are both interference fit on an outer periphery of said stranded conductor.

7. A lead as set forth in claim 6, wherein the sealing portions are located at a given interval along a length of said tube.

8. A rotary electric machine comprising:
a frame which defines a casing;
an electric motor disposed within the casing, said electric motor being equipped with an armature which produces torque through electromagnetic power;
a solenoid switch designed to energize said electric motor selectively; and
a lead including (a) a tube having formed on an end thereof a grommet with a hole secured to said frame, (b) a stranded conductor disposed inside the tube, the stranded conductor having an outer diameter which is substantially identical or smaller than an inner diameter of the hole of the grommet, and (c) a seal provided on the tube which is interference fit on the stranded conductor to establish hermetic sealing between the tube and the stranded conductor, wherein the stranded conductor has a first end portion and a second end portion opposite the first end portion, the first end portion extending through the hole of the grommet to make an electric connection with an internal conductor of said motor within said frame, said stranded conductor extending outside said frame from the first end portion to make an electric connection at the second end portion with a motor terminal of said solenoid switch.
